(19) United States
(12) Patent Application Publication
(10) Pub. No.: US 2013/0323363 A1
(43) Pub. Date: Dec. 5, 2013

(54) INSECT ARTIFICIAL FEEDSTUFF

(71) Applicant: TING-YU CHIANG, (US)

(72) Inventors: TING-YU CHIANG, Taoyuan (TW); CHENG-JEN SHIH, Taoyuan (TW)

(73) Assignee: TING-YU CHIANG, Taoyuan (TW)

(21) Appl. No.: 13/630,823

(22) Filed: Sep. 28, 2012

(30) Foreign Application Priority Data
May 31, 2012 (TW) 101119599

(51) Int. Cl. A23K 1/18; A23K 1/14; A23K 1/16

(52) U.S. Cl. 426/62; 426/573; 426/577; 426/575; 426/576

(57) ABSTRACT

An insect artificial feedstuff is dry powder feedstuff composed of 1 to 50 percent by weight of a gelatinizing agent and 1 to 90 percent by weight of a powder foodstuff to further form gel by adding water having predetermined ratio, wherein the powder foodstuff comprises leaf powder formed by grinding at least one natural forage. Accordingly, other contents geld by utilizing the viscosity of the gelatinizing agent can be obtained to prepare artificial feedstuff having proper softness for different insects. The feeding rate of insect can be increased by the leaf powder, and the commonality of the insect artificial feedstuff can be effectively enhanced.

### BACKGROUND OF THE INVENTION

1. Field of the Invention

The present invention generally relates to a composition formula for insect feedstuff, in particular to an insect artificial feedstuff suitable for feeding phytophagous insects.

2. Description of the Related Art

Recently, insect conservation is paid much attention. Insects are favorite subject of children, and insects have many advantages of different types, quantity, diversity, short life and easy feeding and are specifically applied in educating and teaching natural science and life technology fields of elementary and junior high schools. Therefore, many textbook publishers for elementary school education would select insects as a teaching material (e.g. course units of insect families and insect world) shown in the teaching unit of nature and life technology fields of elementary school curriculum to understand insects.

While learning natural science, insect feeding is also an important course for observation training. To increase the learning effect and school students to have the capability of feeding animals, textbook sellers usually provide in vivo insects to teachers of nature and life technique courses. The feeding process can be completed through careful and patient caring of teachers and students. However, for phytophagous insects, they usually take natural plants as food. In modern city life, natural plants may not be easily obtained and are not easily preserved or planted. Moreover, large space and time may be spent while feeding these insects with natural plants. Consequently, the frustration of feeding insects may be increased since such food for juveniles is not easily obtained or feeding condition is too complicated. Finally, the life habit of insects might be deeply understood by merely watching pictures or video.

Therefore, if natural food can be replaced with artificial feedstuff, the frustration of failure in feeding insects can be reduced to facilitate spreading environmental education or science education. In United States, insect artificial feedstuff is a business. Different kinds of artificial feedstuff for feeding insects based upon research purpose or educational purpose can be bought through Internet.

The research and development of artificial feedstuff in Taiwan, most studies are focused at economic pests. Currently, the techniques of producing animal vaccines taking insects as carriers and expressing exogenous protein are mature. The quantity of producing vaccines via insects is higher than the quantity of producing vaccines via chick embryos. However, the technique of feeding insects through artificial feedstuff is unable to be fed at great quantity. The reason is that conventional insect feedstuff usually takes agar as base material. Gel substance then is fed to insects after forming into blocks. Its preparation process, hot water is used to dissolve agar, and nutrition then is added into the mixture with uniform stir. Vitamin that is easily cracked by heat is further added into the mixture with uniform stir after temperature decreases. Additional water content is removed after cooling the mixture down, the entire process of preparing feedstuff is too complicated and time consuming. Moreover, the used agar may easily cause extremely high hardness of feedstuff such that the feedstuff may not be fed to insects.

Furthermore, the artificial feedstuff formula that is previously developed is merely suitable for targeted insects and not good for commonality. A new artificial feedstuff formula must be researched. If a basic artificial feedstuff can be developed and is suitable for different kinds of phytophagous insects, attractant compound therein for different phytophagous insects is merely added or changed to provide schoolchildren having different choices of feeding phytophagous insects such that teachers and students can conveniently feed first instar juveniles till imago. It does not only increase ease in teaching but also allows students to pay attention to feed insects. Life habits of insects can be understood during feeding process to excite passion of discovering life science.

### SUMMARY OF THE INVENTION

Therefore, it is a primary objective of the present invention to provide an insect artificial feedstuff having convenient usage, better commonality and suitable for feeding phytophagous insects.

To achieve the foregoing objective, the present invention provides an insect artificial feedstuff that is dry powder feedstuff composed of 1 to 50 percent by weight of a gelatinizing agent and 1 to 90 percent by weight of a powder foodstuff to further form gel by adding water having predetermined ratio; wherein the powder foodstuff comprises leaf powder formed by grinding at least one natural forage.

Accordingly, other contents geld by utilizing the viscosity of the gelatinizing agent can be obtained to prepare artificial feedstuff having proper softness for different insects. The feeding rate of insect can be increased by the leaf powder, and during the preparation, other phytophagous insects can be fed as long as other different leaf powders are replaced, the feeding rate of insects can be increased by leaf powder, and the commonality of the insect artificial feedstuff can also be effectively increased.

The insect artificial feedstuff of the invention has the following advantages:

1. By utilizing features of viscosity and dissolving at low temperature from the gelatinizing agent, the practically of the insect artificial feedstuff can be enhanced, and the softness of feedstuff can be regulated by incorporating the liquid gel and the solid gel within the gelatinizing agent.

2. The feeding rate of insects can be increased by utilizing leaf powder, and during the production, different kinds of phytophagous insects can be fed as long as different leaf powders are replaced. The commonality of the insect artificial feedstuff can be effectively enhanced while increasing the feeding rate of insects through leaf powder.

3. During the production, other phytophagous insects can be fed by replacing different leaf powders, thereby effectively enhancing the commonality of insect artificial feedstuff.

4. All compositions are ground into powder in advance. It does not only increase the uniformity of distribution of the composition but is also easily dissolved to increase the convenience of utilization.

5. The insect artificial feedstuff can be used by merely adding warm water or cold water for stirring to facilitate preserving majority of nutrient within the composition and facilitate the growth of insects.

6. The insect artificial feedstuff can be fed to juveniles by merely adding warm water or cold water for stirring around three minutes, thereby greatly increasing the working efficiency of feeding insects.

7. The phenomenon of sticking and drowning first instar juveniles in water can be reduced by utilizing the water retention of the gelatinizing agent, thereby greatly enhancing the survival rate of juveniles.

8. The gelatinizing agent can be utilized to tightly combine with water to slow down the breeding of bacteria, and proper preservative and antibiotics are added therein such that insects can eat the feedstuff at room temperature for seven days to mitigate the burden of feeding insects.

9. The insect artificial feedstuff of the invention is added with water having predetermined ratio to form gel state and can be directly adhered to a vertical wall of the feeding container to prevent the feedstuff from being polluted, thereby reducing the compound of preservative and antibiotics.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a block diagram of basic architecture of an insect artificial feedstuff of the present invention;

### DETAILED DESCRIPTION OF THE PREFERRED EMBODIMENTS

The technical content of the present invention will become apparent by the detailed description of the following embodiments and the illustration of related drawings as follows.

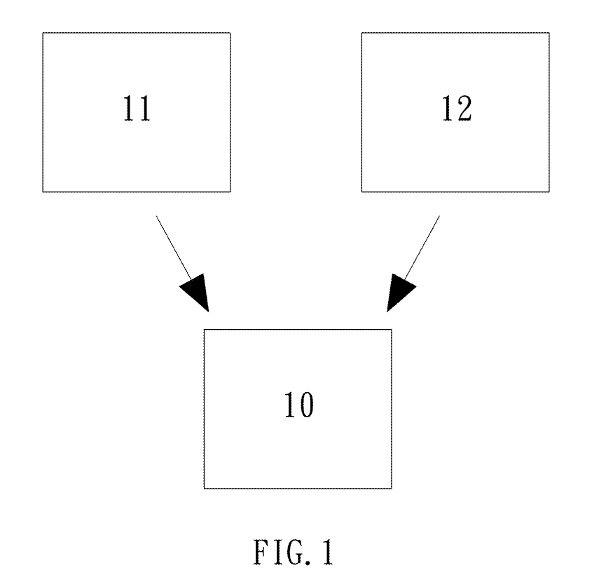

The invention mainly provides an insect artificial feedstuff having convenient usability, better commonality and that is specifically suitable for feeding phytophagous insects. As shown in FIG. 1 for a block diagram of basic composition architecture of the insect artificial feedstuff according to the invention is depicted. The insect artificial feedstuff 10 of the invention is a dry powder feedstuff composed of 1 to 50 percent by weight of gelatinizing agent 11 and 1 to 90 percent by weight of powder foodstuff 20 such that water having predetermined ratio can be added therein to form colloidal gel for utilization, wherein the powder feedstuff 20 further includes at least one leaf powder ground by natural forage. The gelatinizing agent comprises solid gel having predetermined ratio and liquid gel having predetermined ratio, wherein the weight ratio of the solid gel and the liquid gel is 3/2- 1/1.

While implementing the invention, the liquid gel in the gelatinizing agent can be cellulose ether, polysaccharide, vegetable gel or collagen or its synergistic mixture gel selected from the group consisting of C1-4 alkyl and hydroxyl-C1-4 alkyl, wherein the cellulose ether can be selected from the following groups: hydroxymethyl cellulose, methyl cellulose, hydroxyethyl cellulose, hydroxypropyl cellulose, hydroxyethyl methyl cellulose, hydroxyethyl ethyl cellulose or hydroxypropoyl-methyl cellulose.

In addition, the solid gel in the gelatinizing agent can be selected from the following groups: pectin, alginate, carrageen, agar, guar gum, Arabic gum, tragacanth, Karaya, Ghatti, Locust bean powder, Arabian, gellan, konjac poly mannose, poly galacto mannose, funoran, sage, tara gum, xanthans, acetan, welan, rhamsan, furecelleran, succinoglycan, scleroglycan, schizophyllan, tamarind gum, curdlan, pullulan or gelatin.

Moreover, powder natural food in the invention does not only have at least one leaf powder but also includes wheat germ, spirulina, yeast, infant milk powder, sugar, Ascorbic acid, sorbate de potassium, calcium propionate and streptomycin taken as a preservative.

By utilizing the foregoing technical features, the feedstuff suitable for feeding phytophagous insects can be obtained. More specifically, other contents are geld with viscosity of the gelatinizing agent so that artificial feedstuff with moderate hardness can be prepared for different insects. The feeding rate of insects can be increased by leaf powder. While preparing the feedstuff, other kind of phytophagous insects can be fed as long as different leaf powder is replaced. The feeding rate of insects is increased by leaf powder, and the commonality of insect artificial feedstuff can be effectively increased.

It should be noted that in many kinds of phytophagous insects, butterflies are an insect having complete metamorphosis, beautiful body and capable of being easily observed and are the best choice for supporting insect education, wherein Danaidae is the optimum example for mimicry role since most of them have warning colors. Further, in Danaidae, imago color of the biggest idea leuconoe clara is black and white, and image slowly flies and may not be easily scared. Moreover, another anosia chrysippus has colorful and warning color. Due to the foregoing feature, the invention selects two kinds of Danaidaes as test insects to further develop artificial feedstuff to facilitate the learning of school children. Accurate insect knowledge can be acquired from observation and feeding to further care for life and protect the nature.

In Danaidae, juveniles of idea leuconoe clara eat leaves of parsonsia laevigata, and juveniles of anosia chrysippus eat leaves of asclepias curassavica L. According to the insect artificial feedstuff of the invention, leaf powder within powder foodstuff is preferably selected from parsonsia laevigata under implement condition of feeding idea leuconoe clara. Relatively, according to the insect artificial feedstuff of the invention, leaf powder within powder foodstuff is preferably selected from asclepias curassavica L under implement condition of feeding anosia chrysippus.

In the insect artificial feedstuff of the invention, leaf powder therein is selected from parasonsia laevigata while feeding idea leuconoe clara. Powder foodstuff additionally includes wheat germ, spirulian, ueast, infant milk powder, sugar, ascorbic acid, sorbate de potassium, calcium propionate having predetermined ratio and streptomycin taken as preservative and a gelatinizing agent. The gelatinizing agent comprises sodium carboxymethylcellulose as liquid gel and carrageen as solid gel. Under implement condition of taking the foregoing composition as the insect artificial feedstuff (the detail composition of the insect artificial feedstuff is shown in table 1), 10 g insect artificial feedstuff is placed in a plastic container, and 40 g hot water is added to respectively feed 30 juveniles of idea leuconoe clara that are just hatched. Feedstuff is replaced every seven days, and dirt is removed to form the experiment condition. By comparing with another experiment result, fresh leaves of parsonsia laevigata are replaced every day to respectively feed 30 juveniles of idea leuconoe clara that are just hatched, and dirt is removed every day. The survival rate for juveniles to imago of idea leuconoe clara eating the insect artificial feedstuff is 77%. The survival rate for juveniles to image of idea leuconoe clara eating fresh leaves of parsonsia laevigata is 70%.

TABLE 1

| Composition | Weight (grams) |
|---|---|
| Leaf powder (Parsonsia laevigata) | 26 |
| Wheat germ | 12 |
| Spirulina | 3 |
| Yeast | 4 |
| Infant milk powder | 3 |
| Sorbate de potassium | 0.4 |
| Calcium Propionate | 0.7 |
| Sugar | 8 |
| Ascorbic acid | 0.7 |
| Sodium Carboxymethylcellulose | 3 |
| Carrageen | 4 |
| Streptomycin | 0.08 |

The foregoing experiment result can be found that the survival rate for juveniles to imago of idea leuconoe clara eating the insect artificial feedstuff of the invention is slightly higher than the survival rate for juveniles to image of idea leuconoe clara eating fresh leaves of parsonsia laevigata. Moreover, the edibility of the insect artificial feedstuff can achieve above seven days. During the production process, anosia chrysippus can be successfully fed as long as leaf powder of parsonsia laevigata is replaced with leaf powder of asclepias curassavica L. Therefore, the basic insect artificial feedstuff can be suitable for feeding different kinds of phytophagous insects. With respect different phytophagous insects, only leaf powder therein (attractant compound) is added or changed to provide multiple choices for schoolchildren feeding phytophagous insects. Teachers and schoolchildren can conveniently feed first instar juveniles till imago. It does not only increase easy teaching but also allows students to feed insects. The life habit of insects can be understood during feeding process, thereby exciting discovery passion of life science.

By comparing with conventional insect feedstuff, the insect artificial feedstuff of the invention has the following advantages:

1. By utilizing features of viscosity and dissolving at low temperature from the gelatinizing agent, the practically of the insect artificial feedstuff can be enhanced, and the stiffness of feedstuff can be regulated by incorporating the liquid gel and the solid gel within the gelatinizing agent.

2. The feeding rate of insects can be increased by utilizing leaf powder, and during the production, different kinds of phytophagous insects can be fed as long as different leaf powder is replaced. The commonality of the insect artificial feedstuff can be effectively enhanced while increasing the feeding rate of insects through leaf powder.

3. During the production, other phytophagous insects can be fed by replacing different leaf powder, thereby effectively enhancing the commonality of insect artificial feedstuff.

4. All compositions are ground into powder in advance. It does not only increase the uniformity of distribution of the composition but is also easily dissolved to increase the convenience of utilization.

5. The insect artificial feedstuff can be used by merely adding warm water or cold water for stirring to facilitate preserving majority of nutrient within the composition and facilitate the growth of insects.

6. The insect artificial feedstuff can be fed to juveniles by merely adding warm water or cold water for stirring around three minutes, thereby greatly increasing the working efficiency of feeding insects.

7. The phenomenon of sticking and drowning first instar juveniles in water can be reduced by utilizing the water retention of the gelatinizing agent, thereby greatly enhancing the survival rate of juveniles.

8. The gelatinizing agent can be utilized to tightly combine with water to slow down the breeding of bacteria, and proper preservative and antibiotics are added therein such that insects can eat the feedstuff at room temperature for seven days to mitigate the burden of feeding insects.

9. The insect artificial feedstuff of the invention is added with water having predetermined ratio to form gel state and can be directly adhered to a vertical wall of the feeding container to prevent the feedstuff from being polluted, thereby reducing the compound of preservative and antibiotics.

While the means of specific embodiments in the insect artificial feedstuff provided by the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An insect artificial feedstuff being dry powder feedstuff composed of 1 to 50 percent by weight of a gelatinizing agent and 1 to 90 percent by weight of a powder foodstuff to further form gel by adding water having predetermined ratio; wherein the powder foodstuff comprises leaf powder formed by grinding at least one natural forage.

2. The insect artificial feedstuff of claim 1, wherein the gelatinizing agent comprises solid gel having predetermined ratio and a liquid gel having predetermined ratio.

3. The insect artificial feedstuff of claim 2, wherein a value of weight ratio of the solid gel and the liquid gel is 3/2- 1/1.

4. The insect artificial feedstuff of claim 2, wherein the liquid gel in the gelatinizing agent is cellulose ether, polysaccharide, vegetable gel or collagen or its synergistic mixture gel selected from the group consisting of C1-4 alkyl and hydroxyl-C1-4 alkyl.

5. The insect artificial feedstuff of claim 4, wherein the cellulose ether is selected from groups: hydroxymethyl cellulose, methyl cellulose, hydroxyethyl cellulose, hydroxypropyl cellulose, hydroxyethyl methyl cellulose, hydroxyethyl ethyl cellulose or hydroxypropoyl-methyl cellulose.

6. The insect artificial feedstuff of claim 2, wherein the solid gel in the gelatinizing agent is selected from the following groups: pectin, alginate, carrageen, agar, guar gum, Arabic gum, tragacanth, Karaya, Ghatti, Locust bean powder, Arabian, gellan, konjac poly mannose, poly galacto mannose, funoran, sage, tara gum, xanthans, acetan, welan, rhamsan, furecelleran, succinoglycan, scleroglycan, schizophyllan, tamarind gum, curdlan, pullulan or gelatin.

7. The insect artificial feedstuff of claim 6, wherein the at least one leaf powder is one of parsonsia laevigata or asclepias curassavica L.

8. The insect artificial feedstuff of claim 1, wherein the powder foodstuff further comprises wheat germ, spirulina, yeast, infant milk powder, sugar, Ascorbic acid, sorbate de potassium, calcium propionate and a preservative except at least a leaf powder.

9. The insect artificial feedstuff of claim 8, wherein the preservative is streptomycin.

10. The insect artificial feedstuff of claim 1, wherein the at least a leaf powder is one of parsonsia laevigata or asclepias curassavica L.
